(19) United States
(12) Patent Application Publication
(10) Pub. No.: US 2014/0087081 A1
(43) Pub. Date: Mar. 27, 2014

(54) SUSTAINABLE POLY(VINYL CHLORIDE) MIXTURES FOR FLOORING PRODUCTS

(71) Applicant: Stephen D. HORTON, Avon, OH (US)

(72) Inventor: Stephen D. HORTON, Avon, OH (US)

(73) Assignee: PolyOne Corporation, Avon Lake, OH (US)

(21) Appl. No.: 14/090,706

(22) Filed: Nov. 26, 2013

Related U.S. Application Data
(62) Division of application No. 13/003,210, filed on Jan. 7, 2011.
(60) Provisional application No. 61/184,645, filed on Jun. 5, 2009.
(60) Provisional application No. 61/079,822, filed on Jul. 11, 2008.

(51) Int. Cl. C09D 7/12

(52) U.S. Cl. CPC C09D 7/1233
USPC 427/386

(57) ABSTRACT

A mixture of poly(vinyl chloride) and epoxidized methyl soyate is disclosed. The epoxidized methyl soyate as a plasticizer replaces butyl benzyl phthalate which is conventionally used for the manufacture of multi-layer laminate sheet flooring or single layer tile flooring. The epoxidized methyl soyate, a bio-plasticizer, unexpectedly is a “drop-in” replacement for the butyl benzyl phthalate, both in terms of processing and performance. Also poly(vinyl chloride)-epoxidized methyl soyate mixtures have much better heat stability than poly(vinyl chloride)-butyl benzyl phthalate mixtures.

### CLAIM OF PRIORITY

This application claims priority from both U.S. Provisional Patent Application Ser. No. 61/079,822 bearing Attorney Docket Number 12008009 and filed on Jul. 11, 2008 and U.S. Provisional Patent Application Ser. No. 61/184,645 bearing Attorney Docket Number 12009010 and filed on Jun. 5, 2009, which is incorporated by reference.

### FIELD OF THE INVENTION

This invention relates to vinyl mixtures, especially plastisols, made using sustainable plasticizers from renewable resources.

### BACKGROUND OF THE INVENTION

All industrial, construction, and consumer products strive to identify raw materials from renewable resources grown or otherwise harvested from the plant or animal kingdom. The expense and increasing scarcity of petrochemically originating raw materials only accentuate the difficulties of recycling after useful life of products made from such raw materials.

The polymer industry, which had started in the early 20^{th} Century with renewable resources such as natural latex for rubber goods, is now returning to such renewable raw materials whenever possible.

Plastisols are another type of liquid-turn-solid polymer compound, comprising principally particles of polymer resin and a plasticizer which carries the particles before gelation and fusion to make the plastisol into a finally-formed solid plastic article. While one body of research aims for bio-derived resins, another body of research aims for bio-derived plasticizers. An example of the latter is found in U.S. Pat. No. 6,797,753 (Benecke et al.).

### SUMMARY OF THE INVENTION

Development of synthetic or petrochemical raw materials in the later 20^{th} Century in part occurred because those raw materials performed better. An excellent example of that trend is found in the manufacture of flooring from a certain type of phthalate plasticizer to be used with poly (vinyl chloride) resin (PVC).

Because production of sheet flooring requires very fast gelation and fusion times during the continuous layering of liquid materials onto a solid substrate in dimensions of meters across by hundreds of meters long, the only practical plasticizer used in modern flooring manufacturing has been butyl benzyl phthalate (BBP). BBP is neither a renewable resource nor a sustainable ingredient for the long-term flooring industry goals of product life-cycle raw material recovery.

What the art needs is a renewable and sustainable plasticizer to replace BBP without loss of the performance properties which brought the flooring industry to BBP originally.

The present invention solves that problem by using epoxidized methyl soyate (EMS) as a plasticizer for PVC mixtures for the manufacture of flooring.

Unexpectedly, EMS is ultrafast among bio-derived plasticizers in gelation with PVC resin and has very high heat stability before, during, and after fusion. Most unexpectedly, EMS is a “drop-in” replacement for BBP for vinyl-based flooring products, meaning very few alterations, if any, are needed to the manufacturing equipment or the manufacturing process.

To understand the importance of the invention, some words need to be specifically defined:

“Gelation” is the movement of the plasticizer into the cavities, interstices, and other openings of the solid PVC resin particle. The particle preferably has a high surface area/mass ratio. This penetration of plasticizer into each particle begins the process of converting the plastisol, a flowable liquid, into a solid plastic upon heating.

The “rate of gelation” or “gel rate” is the pace of gelation for a given plasticizer and a given resin. The faster the gel rate, the faster the machinery can be operated to commence an early step toward converting a flowable liquid into a solid layer on a substrate.

The “gel point” is the temperature at which gelation noticeably has commenced and often is the extrapolation of two lines having different slopes on a graph before and during gelation.

“Fusion” is the conversion a gelled plastisol on a substrate into a solid solution of plasticizer and resin to form a solid layer on that substrate.

The “rate of fusion” or “fusion rate” is the pace of fusion to complete the formation of the solid layer as measured by the increased mechanical properties as the temperature is increased until the ultimate properties are reached usually at about 190-205° C. (375-400° F.).

For the flooring industry to have adequate economies of scale during manufacturing, one needs the interaction of plasticizer and resin particles during both gelation and fusion to be very fast because of the area of substrate (length and width or X-Y dimensions) being continuously covered with a flowable liquid. Once the plastisol becomes a new layer in the flooring product, it needs to have excellent heat stability and other physical properties.

With an already excellently performing flooring plastisol using BBP, it is totally unexpected that a plasticizer such as EMS can become a drop-in replacement for sheet flooring.

Moreover, the performance of EMS in sheet flooring as a drop-in replacement for BBP also makes EMS suitable for use in polyvinyl chloride compound formulations used to make tile flooring via calendering processes. Tile flooring made using polyvinyl chloride compounds is also known in the industry as “vinyl composite tile”, “vinyl composition tile”, or “VCT”.

Therefore, one aspect of the present invention is a mixture, comprising (a) polyvinyl chloride resin and (b) an effective amount of epoxidized methyl soyate to provide gelation of the mixture substantially as fast as butyl benzyl phthalate provides gelation of a mixture of the polyvinyl chloride resin and the butyl benzyl phthalate. Preferably, the effective amount is to provide both gelation and fusion of the mixture substantially as fast as butyl benzyl phthalate provides both gelation and fusion of the mixture of polyvinyl chloride resin and the butyl benzyl phthalate.

“Substantially as fast” means that the gel point (in ° C.) of PVC-EMS is the gel point of PVC-BBP, plus up to 10%. More than a 10% difference in gel points means that the processing conditions or equipment of an industrial scale flooring product manufacture would require expensive alterations.

The amount of EMS as plasticizer can be either a similar or same amount as BBP used for sheet flooring or for tile flooring.

Another aspect of the present invention is a layer of flooring made from the mixture described above, whether it be sheet flooring or tile flooring.

Another aspect of the present invention is a method of making sheet flooring, comprising the steps of (a) applying to a substrate a plastisol described above at a temperature to induce gelation of the plastisol and (b) heating the plastisol and the substrate to fuse the plastisol into a solid layer affixed to the substrate.

Another aspect of the present invention is a method of making tile flooring, comprising the steps of (a) mixing polyvinyl chloride and epoxidized methyl soyate and filler to form a mixture; (b) calendering the mixture to form a layer; and (c) cutting the layer into tile.

Features and advantages of the invention will be explained in respect of the various embodiments with reference to the following drawings.

### BRIEF DESCRIPTION OF THE DRAWING

FIG. 1 is a cross-sectional view of a typical multi-layer flooring product.

FIG. 2 is a graph showing gelation curves and gel points for Comparative Examples A-D and Examples 1 and 2.

FIG. 3 is a digital image of a heat stability test for Comparative Examples A-D and Examples 1 and 2.

### EMBODIMENTS OF THE INVENTION

Flooring Product

The structure of the flooring product is not new; the type of materials employed is. As used in this document and explained above, “flooring” can include both sheet flooring and tile flooring. In both instances, the thickness of the flooring is a minor fraction of the length and width dimensions of the sheet or tile. For purposes of explanation of this invention, sheet flooring will be embodied because it is a multi-layer laminate structure whereas composite tile is often merely a single layer, although sometimes also having adhesive or web reinforcement or both applied to the under-surface.

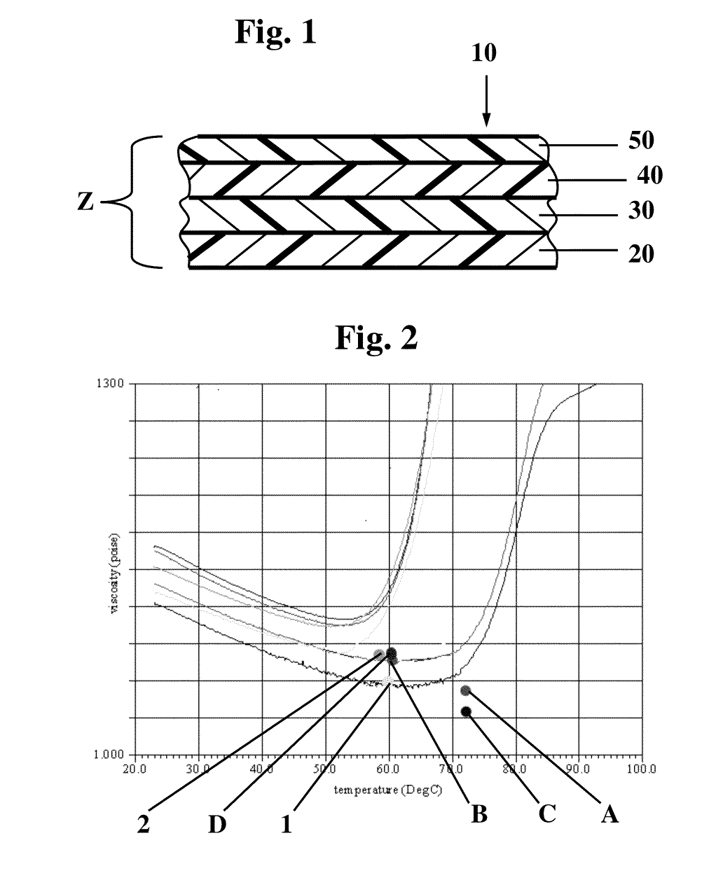

With respect to the embodiment of sheet flooring, FIG. 1 shows a conventional sheet flooring product, in cross-section. The flooring 10 has multiple layers 20 and 30 and optionally additional layers 40 and 50.

Layer 20 is the foundational substrate upon which all others layers constructed. Any conventional substrate is a suitable material, depending on other flooring performance considerations such as location of the flooring inside or outside of a structure. Typically, layer 20 can be made from felt or from polyvinyl chloride often containing recycled materials. Layer 20 can have a thickness ranging from about 0.25 to about 1.25, and preferably from about 0.50 to about 0.75 mm.

Layer 30 is a layer made from a plastisol of the present invention. Typically, layer 30 can include functional additives such as foaming agents (to provide cushioning in the flooring) or fillers (to provide wear resistance) or both. When layer 30 is the final, exposed layer of the flooring product, it can have a thickness ranging from about 0.38 to about 3.0, and preferably from about 0.65 to about 2.0 mm More often, layer 30, with foaming agents, is an underlayer beneath another layer or layers. When layer 30 is an underlayer, it can have a thickness ranging from about 0.35 to about 1.60, and preferably from about 0.60 to about 1.20 mm once fused and expanded.

Layer 40 is an optional layer depending on the desire of the manufacturer of the flooring. If more than one PVC plastisol layer is desired, then layer 40 is the upper layer and contains the wear resistance functional additives. If a different material is desired to cover layer 30, then layer 40 can be a different wear resistant layer such as a urethane-acrylate layer now commonly used as the uppermost layer of the flooring product. When layer 40 is a PVC plastisol layer, it can have a thickness ranging from about 0.12 to about 1.2, and preferably from about 0.20 to about 1.0 mm When layer 40 is made from a different material to serve as the uppermost, exposed layer, it can have a thickness ranging from about 0.02 to about 0.08, and preferably from about 0.027 to about 0.051 mm.

Layer 50 is even more optional than layer 40 and is commonly used as the uppermost, exposed layer made from a different material such as a urethane-acrylate material. Therefore, its thickness is already described with respect to layer 40.

Therefore, accumulating the thicknesses of the various embodiments of layers 20-30, 20-40, and 20-50, one can compute typical flooring has a thickness ranging from about 0.74 to about 4.13, and preferably from about 1.33 to about 3.00 nm. This Z dimension of the flooring is built from layer 10 in a single manufacturing operation.

Sheet flooring can be made in extremely large surfaces in the X-Y dimension. It is not uncommon for a single roll of finished flooring product to be as much as 100 meters long, or more, and as much as 5 meters wide. This latter Y dimension in combination with the pace of manufacture becomes critical factors in efficient flooring manufacture. Across the entire width Y of flooring 10, the application of layer 30 (and optionally layer 40) requires the PVC-EMS plastisol of the present invention to have substantially as fast a gelation and fusion as a PVC-BBP plastisol would have, if one were to want the PVC-EMS plastisol to be a drop-in replacement for the PVC-BBP plastisol. More explanation will become apparent in the Examples below.

While many flooring manufacturers would desire not to disrupt their current manufacturing efficiencies, it is possible that a PVC-EMS plastisol of the present invention to operate even faster than a PVC-BBP plastisol. But what makes the plastisol of the present invention so unexpected is that other bio-derived plasticizers are much, much slower than BBP in gelation and fusion. As such, those other bio-derived plasticizers are totally unsuitable for use in the flooring industry according to the present economies of scale and manufacturing efficiencies.

It is expected that flooring manufacturers of tile flooring can also benefit from the invention, because BBP is also used in that product. Whereas, sheet flooring is a multi-laminate having the Z dimension described above, tile flooring typically is a single layer and has a thickness ranging from about 1.8 to about 3.5 mm and preferably from about 2.8 to about 3.2 mm.

Mixtures of the Invention

PVC Resin for Sheet Flooring Plastisol

The polymer processing art is quite familiar with vinyl plastisols. The PVC resin used are typically dispersion-grade poly(vinyl chloride) (PVC) resins (homopolymers and copolymers). Exemplary dispersion-grade PVC resins are disclosed in U.S. Pat. Nos. 4,581,413; 4,693,800; 4,939,212; and 5,290,890, among many others such as those referenced in the above four patents. Any PVC resin which has been or is currently being used to make sheet flooring products is a candidate for use in the present invention. Without undue experimentation, one skilled in the art can determine gel point, gel rate, and other gelation properties of a PVC resin in performance with epoxidized methyl soyate.

PVC Resin for Tile Flooring Compound

In a similar manner, the polymer processing art is also quite familiar with vinyl resins used to make tile flooring.

Vinyl resins useful for tile flooring comprise essentially a homopolymer with minimal amounts of less than about 5% by weight copolymerized other vinyl comonomer, but preferably little or no copolymerized other vinyl monomer. Commercial PVC resin ordinarily comprises about 56% by weight chlorine and has a Tg of about 81° C.

Preferred PVC resins are essentially homopolymers of polymerized vinyl chloride. Useful vinyl co-monomers if desired include vinyl acetate, vinyl alcohol, vinyl acetals, vinyl ethers, and vinylidene chloride. Other useful co-monomers comprise mono-ethylenically unsaturated monomers and include acrylics such as lower alkyl acrylates or methacrylates, acrylic and methacrylic acids, lower alkyl olefins, vinyl aromatics such as styrene and styrene derivatives, and vinyl esters. Useful commercial co-monomers include acrylonitrile, 2-hexyl acrylate, and vinylidene chloride. Although co-monomers are not preferred, useful PVC copolymers can contain from about 0.1% to about 5% by weight copolymerized co-monomer, if desired.

Preferred PVC resins for tile flooring are suspension polymerized vinyl chloride monomer, although mass (bulk) and dispersion polymerized polymers can be useful, but are less preferred. PVC resins can have an inherent viscosity from about 0.45 to about 1.5, preferably from about 0.5 to about 1.2, as measured by ASTM D 1243 using 0.2 grams of resin in a 100 ml of cyclohexanone at 30° C.

Plasticizer

Whether the end product is sheet flooring or tile flooring, the plasticizer is epoxidized methyl soyate, a biologically derived substance formed from soy oils, which in turn have been formed from naturally occurring fatty acids. As discussed above, U.S. Pat. No. 6,797,753 (Benecke et al.), incorporated by reference herein, is an excellent resource to one skilled in the art in understanding the value of using a bio-derived plasticizer with PVC resin. EMS is unexpectedly different from the others discussed in Benecke et al. because it has unusually fast gelation and fusion properties. Therefore, EMS is the primary plasticizer for this invention.

Commercially available EMS is available as Nexo E1 brand epoxidized methyl soyate from Nexoleum Bioderivados, Ltda. Cotia, Brazil and as Vikoflex 7010 from Arkema, Inc.

Vinyl plastisols (liquid) or vinyl compounds (solid) can have other plasticizers because an additional plasticizer might provide other properties desirable during processing or performance. While not preferred in the present invention, it is possible that a additional plasticizer could be any of the bio-derived plasticizers disclosed by Benecke et al. or an organic ester of various acids such as phthalic, phosphoric, adipic, sebacic and the like. Specific examples of useful additional plasticizers include epoxidized propylene glycol disoyate, dioctyl phthalate, dioctyl adipate, dibutyl sebacate, and dinonyl phthalate and glyceryl stearates.

Vinyl plastisols for sheet flooring are typically liquid at room temperature and can be poured, pumped, sprayed or cast, depending on the formulation. These compounds can range in hardness from fishing lure plastisol with an 8 Durometer Shore A or lower, to rotocasting plastisol (mostly PVC) with a 65 Durometer Shore D and above. Advantages of vinyl plastisol in coating and sheet forming applications include ease of use and economy.

Vinyl compounds for tile flooring are nearly rigid chips or pellets and are calendered into final shape before cutting into tile sizes.

Optional Frothing Agents

Flooring can also benefit from vinyl plastisols of the invention which include frothing agents. As explained in U.S. Pat. No. 3,945,955 (Ihde) and U.S. Pat. No. 3,970,620 (Ihde et al.), silicone frothing agents can be used with polyvinyl chloride compounds to generate foamed structures. Alternatively, non-silicone frothing agents can be used, as explained in U.S. Pat. No. 4,595,617 (Bogdany). As explained in Bogdany and PCT Publication WO/2008/094605 (Bergman et al.), foamed structures made with frothing agents can be used to make carpet tiles and carpet backing, respectively.

For this invention, frothing agents can optionally be used. To assist in frothing, frothing aids can also optionally be included in the plastisol, as explained in detail by Ihde. The frothing aid can serve to extend the frothing agent.

Of the two types of frothing agents, silicone-based frothing agents are preferred because of two reasons: (1) the resulting structure of the foamed plastisol containing EMS, such as layer 30 in FIG. 1, is a new construction because BBP (for which EMS is a “drop-in replacement”) can not be formulated with silicone-based frothing agents and (2) silicone-based frothing agents contribute increased hydrophobicity to the foamed plastisol containing EMS which aids in repelling absorption of hydrophilic fluids to minimize staining which might result from such absorption.

As explained by Ihde, non-limiting examples of silicone-based frothing agents include are copolymers of SiO₂ units and units selected from the group consisting of (CH₃)₃ SiO_{1/2} and Q(CH₃)₂ SiO_{1/2} units, wherein Q is a radical containing a solubilizing group that makes the copolymer compatible with the plastisol and the ratio of SiO₂ units to the total (CH₃)₃Si and Q(CH₃)₂Si unit is in the range of 1:0.6 to 1:1.2.

These copolymers can be prepared by the cohydrolysis of (CH₃)₃ SiX and/or Q(CH₃)₂ SiX with SiX₄, wherein X is a phosphate le radical such as a halogen (chlorine, fluorine, bromine) or any alkoxy (methoxy, ethoxy, propoxy, butoxy, etc.) radical, employing, of course, such proportions as are necessary to obtain the desired SiO₂ to total (CH₃)₃ Si and Q(CH₃)₂ Si ratio of 1:0.6 to 1:1.2. Alternatively, such copolymers can be prepared, for example, by reacting (CH₃)₃ SiCl, (CH₃)₃—SiOC₂H₅ or (CH₃)₃ SiOSi(CH₃)₃ with an acidic silica sol. This method is fully described in U.S. Pat. No. 2,676,182.

As also explained by Ihde, non-limiting examples of frothing aids for silicone-based frothing agents include a mixture of the free acids of simple and complex organic phosphate mono and diesters and phosphate mono and diesters, organic nitrogen compounds such as amines, aminoamides, alkanolamides, imidazolines, quaternaries, and nitrogen-sulfur compounds, simple and complex organic borate esters such as 2-ethyl-hexyl borate, tri-hexylene glycol biborate, and tricresyl borates in combination with simple and complex olephilic organic metallic compounds such as a metal phenate, metal soap or metal organosulfonate. Preferably, the frothing aid is a mixture of an overbased calcium phenate, a free acid of an oleyl alcohol ethoxylate phosphate ester, and a 2-ethylhexyl borate.

If non-silicone frothing agents are used, then as explained in Bogdany above, non-limiting examples of such non-silicone frothing agents include urea, the sodium salt of condensed naphthalene sulfonic acid, mixed C₈-C₁₈ fatty alcohols, ammonium or sodium lauryl sulfate and water.

Other Optional Additives

A variety of ingredients commonly used in the coatings or plastics compounding industries can also be included in the mixture of the present invention. Non-limiting examples of such optional additives include blowing agents, slip agents, antiblocking agents, antioxidants, ultraviolet light stabilizers, quenchers, plasticizers, mold release agents, lubricants, antistatic agents, fire retardants, and fillers such as glass fibers, talc, chalk, or clay.

Any conventional colorant useful in coatings and paints or plastics compounding is also acceptable for use in the present invention. Conventional colorants can be employed, including inorganic pigments such as titanium dioxide, iron oxide, chromium oxide, lead chromate, carbon black, silica, talc, china clay, metallic oxides, silicates, chromates, etc., and organic pigments, such as phthalocyanine blue, phthalocyanine green, carbazole violet, anthrapyrimidine yellow, flavanthrone yellow, isoindoline yellow, indanthrone blue, quinacridone violet, perylene reds, diazo red and others.

Table 1 shows the acceptable, desirable, and preferable ranges of amounts, in weight percents, of PVC resin, EMS primary plasticizer, and optional additives for each of the PVC containing layers of sheet flooring described above or the calendered layer of tile flooring.

TABLE 1
Formulations

| | | | |
|---|---|---|---|
| Ingredient | Acceptable | Desirable | Preferable |

Wear Layer of Sheet Flooring

| | | | |
|---|---|---|---|
| PVC Resin | 50-75 | 55-73 | 60-70 |
| EMS Primary | 15-40 | 17-35 | 20-30 |
| Plasticizer | | | |
| Optional Additives | 0-25 | 5-20 | 10-15 |

Foam Layer of Sheet Flooring

| | | | |
|---|---|---|---|
| PVC Resin | 40-70 | 45-65 | 50-60 |
| EMS Primary | 10-35 | 12-30 | 15-25 |
| Plasticizer | | | |
| Foam, Filler, etc. | 15-35 | 20-35 | 25-30 |
| Additives | | | |
| Optional Frothing | 0.8-2.8 | 0.9-2.6 | 1-2.4 |
| Agent | | | |
| Optional Frothing | 2-7 | 2.25-6.5 | 2.5-6 |
| Aid | | | |

Layer of Tile Flooring

| | | | |
|---|---|---|---|
| PVC Resin | 5-15 | 7-14 | 8-12 |
| EMS Primary | 2-10 | 3-7 | 4-6 |
| Plasticizer | | | |
| Filler, Colorant, etc. | 75-95 | 80-90 | 83-87 |
| Additives | | | |

Processing

Mixing of PVC Resin and Plasticizer for Plastisol

Conventional mixing equipment is used to thoroughly mix the plastisol, either in batch or continuous operations.

Mixing in a batch process typically occurs in a low shear mixer with a prop-type blade operating at a temperature below 37° C. The mixing speeds range from 60 to 1000 rpm. The output from the mixer is a liquid dispersion ready for later coating on to a substrate to form a multi-layer laminate sheet flooring product.

Mixing of PVC Resin and Plasticizer for Solid Compound

Mixing in a batch process typically occurs in a Banbury-type internal mixer operating at a temperature high enough to fuse, or flux, the combination of PVC and plasticizer. The mixing speeds are typically above 1000 rpm in order to mechanically heat the mixture above the fusion, or flux, point. The output from the mixer is a solid compound in chips or pellets for later calendering into a single layer have a thickness useful for making tile flooring.

### USEFULNESS OF THE INVENTION

All of the advantages and usefulness of a vinyl plastisol or vinyl compound made using PVC and BBP can now be achieved using a plastisol or a compound made from PVC and EMS. Without significant alteration of tried and true manufacturing processes, one can now utilize a bio-derived plasticizer which aids in the issue of sustainability now confronting all types of manufacturing. Indeed, all of the conventional coating techniques for vinyl plastisols and all of the conventional calendering and cutting techniques for vinyl compounds are also available for the present invention.

Coating Techniques

Dip Coating: When the plastisol coating becomes a functional part of the mold itself, the process is called dip coating. The metal insert may or may not have a requirement for an adhesive primer. Common uses include tool handles and grips; textiles; wire grates and baskets; plating racks; conveyor hooks; and the like. Dip coating can be either hot dipping or cold dipping.

Hot Dipping: By far the most common dip-coating processing technique, hot dipping requires an item to be heated first before immersion into the plastisol. The heat causes the plastisol coating to gel on the hot form.

Cold Dipping: Preheating the metal part is not required; the amount of pickup obtained depends largely on the viscosity and thixotropic ration of the plastisol.

Molding: Several types of molding are common to plastisol applications. Slush Molding is used to produce hollow, flexible items by filling a mold with plastisol, heating sufficiently to gel a layer next to the inner mold surface, and then draining the excess plastisol. The gelled layer is then completely fused and stripped from the mold. Rotational Molding involves hollow flexible or rigid forms with complex shapes. The process is done using a two-part mold filled with a predetermined weight of plastisol, inserted into a heated oven and rotated on two planes simultaneously. Dip Molding refers to the process of dipping a solid mold; gelling, fusing and stripping the hollow part. Open Molding is a process of molding directly in, or into, a finished article such as automotive air filters.

Other Coating: Several types of coating employ movement of the plastisol relative to the item or the item relative to the plastisol. One skilled in the art readily can employ knife coating, roll coating, reverse roll coating, etc. according to techniques taught in encyclopedias, other technical literature, or the patent literature, without undue experimentation. One reason for such easy adaptation of the mixtures of the present invention to conventional plastisol coating using BBP is that the presence of EMS functions substantially as if it were BBP with the unexpected and added benefit that plastisols made from EMS have lower viscosity than those made from BBP, which typically results in increased ease of processing.

Vinyl plastisols can be certified for end-use automotive, UL, ASTM, NSF, USDA, military, medical or customer-specific applications.

Any article that presently uses BBP as a plasticizer is a beneficiary of a PVC-EMS mixture of the present invention. As mentioned several times, sheet flooring is the principal end product of a PVC-BBP plastisol.

Sheet flooring manufacture, at its most basic, can be described comprising the steps of (a) applying to a substrate a plastisol described above at a temperature to induce gelation of the plastisol and (b) heating the plastisol and the substrate to fuse the plastisol into a solid layer affixed to the substrate. The two-layer laminate can then be used or subjected to additional steps of applying another liquid and heating to fuse that liquid, iteratively, until the final desired multi-layer laminate is produced. FIG. 1 is a representative multi-layer laminate.

More information about the manufacture of sheet flooring can be found in U.S. Pat. No. 5,458,953 (Wang et al.); U.S. Pat. No. 5,670,237 (Shulz et al.); U.S. Pat. No. 5,961,903 (Eby et al.); and U.S. Pat. No. 5,981,058 (Shih et al.), all incorporated by reference herein and many other patents owned by Mannington Mills, Inc. of Salem, N.J.

Because EMS is a “drop-in” replacement for BBP, one of ordinary skill in the art of multi-layer laminate flooring manufacture can use the same manufacturing parameters and processing conditions as are now used in the commercial manufacture of such laminate flooring using BBP as a plasticizer. The use of EMS primary plasticizer in this invention minimizes departures from industrial-scale manufacture of conventional laminate sheet flooring.

Calendering Techniques

Tile flooring, containing vinyl compound and optionally other resins, differs from sheet flooring because it is made using a Banbury-type internal mixer, followed by calendering and cutting into desired size. With very similar gelation and fusion rates, it is believed that the heat stable EMS will function comparably if not better than BBP in a tile flooring formulation subjected to calendering and cutting into tiles of, for example, approximately 30.4 cm×30.4 cm in size. Indeed, the art of making vinyl tile flooring is very well known, such as that described in U.S. Pat. No. 4,180,615 (Bettoli) and U.S. Pat. No. 4,239,797 (Sachs), both incorporated by reference herein, and others owned by GAF Building Materials Corporation.

Further embodiments are described in the following examples.

### EXAMPLES

Table 2 shows the source of the ingredients and the amounts used to prepare Comparative Examples A-D and Examples 1-2. Comparative Examples A and C used diisononyl phthalate (DINP), a well-known plasticizer for polyvinyl halides but one which does not have a gelation time fast enough for flooring manufacturing. Comparative Examples B and D used BBP. Examples 1 and 2 used EMS.

Comparative Examples A-D added a minor amount of epoxidized soybean oil as a additional plasticizer because it is commonly used as a thermal co-stabilizer and found in most plastisol formulations.

All Comparative Examples A-D and Examples 1-2 had a minor amount of thermal stabilizer to prevent the dehydrochlorination that can result at the temperatures commonly used to fuse plastisol.

Comparative Examples A and B and Example 1 differed from Comparative Examples C and D and Example 2 because the former set was formulated for equal amounts of plasticizer, whereas the latter set was formulated to obtain very similar Shore A hardness values.

TABLE 2
Formulations

| | Example | | | | | | | | | | | |
|---|---|---|---|---|---|---|---|---|---|---|---|---|
| | A | | B | | 1 | | C | | D | | 2 | |
| Amount | PHR | Wt. % | PHR | Wt. % | PHR | Wt. % | PHR | Wt. % | PHR | Wt. % | PHR | Wt. % |
| Geon 121AR PVC resin | 100 | 58.1 | 100 | 58.1 | 100 | 58.5 | 100 | 56.5 | 100 | 58.1 | 100 | 60.2 |
| (PolyOne) CAS No. | | | | | | | | | | | | |
| 9002-86-2 | | | | | | | | | | | | |
| Diisononyl Phthalate | 67 | 39.0 | | | | | 72 | 40.7 | | | | |
| (DINP) (ExxonMobil) | | | | | | | | | | | | |
| CAS No. 28553-12-0 | | | | | | | | | | | | |
| Butyl Benzyl Phthalate | | | 67 | 39.0 | | | | | 67 | 39.0 | | |
| (BBP) (Ferro, Walton | | | | | | | | | | | | |
| Hills, OH USA) CAS | | | | | | | | | | | | |
| No. 85-68-7 | | | | | | | | | | | | |
| Epoxidized Methyl | | | | | 70 | 40.9 | | | | | 65 | 39.2 |
| Soyate (EMS) | | | | | | | | | | | | |
| (Nexoleum Bioderivados, | | | | | | | | | | | | |
| Ltda. Cotia, Brazil) CAS | | | | | | | | | | | | |
| No. 68082-35-9 | | | | | | | | | | | | |
| Therm-Chek 120 LOHF | 2 | 1.2 | 2 | 1.2 | 1 | 0.6 | 2 | 1.1 | 2 | 1.2 | 1 | 0.6 |
| Barium-zinc stabilizer | | | | | | | | | | | | |
| mixture (Ferro) | | | | | | | | | | | | |
| Epoxidized Soybean Oil | 3 | 1.7 | 3 | 1.7 | | | 3 | 1.7 | 3 | 1.7 | | |
| (ESO) | | | | | | | | | | | | |
| CAS No. 8013-07-8 | | | | | | | | | | | | |
| Total | 172 | 100.0 | 172 | 100.0 | 171 | 100.0 | 177 | 100.0 | 172 | 100.0 | 166 | 100.0 |

Table 3 shows the method of preparation for all Comparative Examples A-D and Examples 1-2.

TABLE 3
Preparation

| | |
|---|---|
| Mixing Equipment | Planetary Dough Type Mixer |
| Mixing Temp. | Kept Below 35° C. |
| Mixing Speed | Lowest Setting |
| Order of Addition | Order listed in Table 1 |
| Form of Product | Liquid Dispersion |

Table 4 shows the physical properties of Comparative Examples A-D and Examples 1-2.

TABLE 4
Physical Properties

| Example | | | | | |
|---|---|---|---|---|---|
| A | B | 1 | C | D | 2 |

Brookfield RV Viscosity ASTM No. D1824

| | | | | | | |
|---|---|---|---|---|---|---|
| Spindle | 3 | 4 | 3 | 3 | 4 | 3 |
| Initial @ | 2,400 | 4,310 | 1,670 | 1,740 | 4,630 | 2,645 |
| 20 rpm, cps | | | | | | |
| Initial @ | 2,350 | 3,800 | 1,600 | 1,600 | 3,900 | 2,550 |
| 2 rpm, cps | | | | | | |
| Spindle | 3 | 4 | 3 | 3 | 4 | 3 |
| 1 Day @ | 3,300 | 5,790 | 2,285 | 2,050 | 6,610 | 3,660 |
| 20 rpm, cps | | | | | | |
| 1 Day @ | 3,650 | 4,700 | 2,200 | 1,850 | 5,600 | 3,400 |
| 2 rpm, | | | | | | |
| ZSQXcps | | | | | | |
| Spindle | 3 | 4 | 3 | 3 | 4 | 3 |
| 5 Day @ | 3,500 | 7,200 | 3,170 | 2,550 | 8,310 | 4,800 |
| 20 rpm, cps | | | | | | |
| 5 Day @ | 3,400 | 6,600 | 3,600 | 2,750 | 7,600 | 5,350 |
| 2 rpm, cps | | | | | | |
| Spindle | 3 | 4 | 3 | 3 | 4 | 3 |
| 8 Day @ | 4,100 | 6,790 | 3,190 | 2,180 | 8,670 | 4,800 |
| 20 rpm, cps | | | | | | |
| 8 Day @2 | 4,600 | 5,600 | 3,050 | 1,850 | 7,700 | 4,750 |
| rpm, cps | | | | | | |

Hardness (Shore A Scale)
ASTM No. D2240 Samples were 15 g fused samples

| | | | | | |
|---|---|---|---|---|---|
| 80 | 78 | 73 | 78 | 78 | 77 |

Gloss ASTM No. D523
Samples were approx 0.5 mm (20 mil) fused films.

| | | | | | | |
|---|---|---|---|---|---|---|
| 20° Gloss/ | 25.5% | 40.6% | 14.0% | 29.0% | 43.1% | 13.8% |
| 5″@350° F. | | | | | | |
| 20° Gloss/ | 58.1% | 94.5% | 64.1% | 81.7% | 87.2% | 62.0% |
| 3″@390° F. | | | | | | |
| 60° Gloss/ | 70.8% | 83.1% | 56.4% | 73.7% | 85.0% | 55.9% |
| 5″@350° F. | | | | | | |
| 60° Gloss/ | 88.2% | 97.8% | 79.7% | 93.3% | 91.4% | 78.0% |
| 3″@390° F. | | | | | | |

Haze ASTM No. D1003
Samples were approx 0.5 mm (20 mil) fused films.

| | | | | | |
|---|---|---|---|---|---|
| 14.7% | 33.8% | 18.5% | 12.9% | 29.4% | 18.1% |

Transmittance ASTM No. D1003
Samples were approx 0.5 mm (20 mil) fused films.

| | | | | | |
|---|---|---|---|---|---|
| 94.6% | 93.2% | 95.3% | 95.0% | 93.0% | 95.6% |

Stress-Strain ASTM No. D638 (Type 4)
Samples were approx 0.5 mm (20 mil) fused films.

| | | | | | | |
|---|---|---|---|---|---|---|
| Stress (psi) | | | | | | |
| 325° F. | 2560 | 2880 | 2390 | 2260 | 2800 | 2660 |
| 350° F. | 2710 | 2800 | 2500 | 2720 | 2940 | 2770 |
| 375° F. | 3100 | 3200 | 2530 | 2430 | 2950 | 2860 |
| 400° F. | 2790 | 3010 | 2880 | 2520 | 3100 | 2980 |
| Strain (%) | | | | | | |
| 325° F. | 401 | 373 | 425 | 369 | 372 | 435 |
| 350° F. | 427 | 347 | 437 | 433 | 371 | 434 |
| 375° F. | 430 | 344 | 418 | 392 | 379 | 424 |
| 400° F. | 431 | 348 | 423 | 412 | 347 | 420 |

Gel Point

| | | | | | |
|---|---|---|---|---|---|
| 72° C. | 60° C. | 60° C. | 72° C. | 60° C. | 58° C. |

The data seen in FIG. 2 and the Gel Points reported in Table 4 were created using a Carri-Med CL2 500 rheometer with a 4 cm stainless steel flat type spindle. A small amount of the liquid plastisol sample was placed between the spindle and a Peltier plate. The temperature of the Peltier plate was then increased at a rate of 0.1° C. every 2 seconds while the spindle was rotated. The resulting torque on the spindle was then converted to viscosity and plotted versus temperature. The gel point, a point of intersection of the slope of the asymptote of the liquid state and the slope of the asymptote of the solid state, was then determined and added manually to the plot.

Table 4 first demonstrates that, unexpectedly, EMS is a drop-in replacement for BBP because the gel point comparisons of Comparative Example B with Example 1 and Comparative Example D with Example 2 are nearly identical or so similar, which is quite important for processing of flooring designed to work with BBP. It should be noted that the use of ESO as a primary plasticizer in a similar experiment resulted in a gel point of 72° C. (much like DINP) and the use of epoxidized propylene glycol disoyate in a similar experiment resulted in a gel point of 68° C. Therefore, among bio-plasticizers, only EMS has been found suitable as a drop-in replacement for BBP.

Table 4 next demonstrates, unexpectedly, that flow properties can be managed such that the EMS of Example 2 has better viscosity than the BBP of Comparative Example D at comparable temperatures, which improves processing conditions during the manufacture of flooring.

Table 4 next demonstrates that, unexpectedly, the formulations can be managed to provide identical or very similar hardness values between Comparative Example D and Example 2, which is quite important for the performance of flooring produced using EMS as a drop-in replacement for BBP.

Table 4 next demonstrates, also unexpectedly, that a renewable and sustainable EMS plasticizer results in a plastisol which when formed into a film has comparable and acceptable physical properties of stress and strain, haze and transmittance, gloss, and Brookfield viscosity aging.

Comparative Examples A and C were provided to demonstrate that gel points for DINP-plasticized plastisols were unacceptable for flooring usages because of relatively slow gelation and fusion rates.

One of ordinary skill in the art of making plastisols will recognize the significance of the invention when examining FIG. 2. The sharpness of the rise in viscosity for Comparative Examples B and D and Examples 1 and 2 show to that person the enormous value of providing a plastisol made using EMS which mimics the processing properties of BBP. For all of the reasons explained above, the substitution of plasticizer to a renewable and sustainable resource is now possible.

As Table 4 and FIG. 2 demonstrate, EMS provides gelation of a PVC plastisol substantially as fast as butyl benzyl phthalate provides for the same PVC resin.

Volatility loss of EMS was 12.2% as measured by placing one gram of plasticizer in an aluminum dish and subjecting the sample to 205° C. for 3 minutes and measuring the weight loss and favorably compared with BBP. The BBP volatility loss was measured as 3.6%. Relatively high volatilities are important because volatile loss of plasticizer from the surface of sheet flooring is used to increase the wear and stain resistance of the flooring. The fact that the volatility of EMS greater than BBP is unexpected because other common bio-derived plasticizers have volatilities well below that off BBP. For example, using the same technique, the volatile loss of ESO is 0.2%

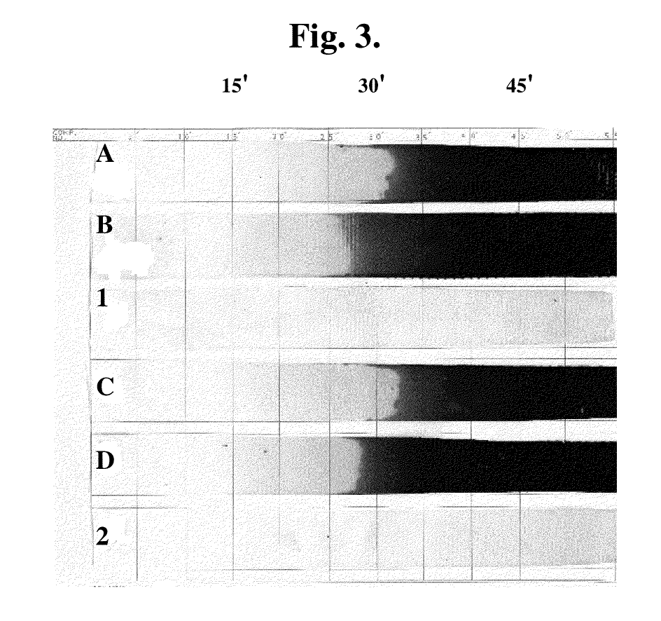

Finally, heat stability of Examples 1 and 2 is far superior to those of Comparative Examples A and B and Comparative Examples C and D, respectively. Using the Metrastat Aging test operating at 191° C. according to ASTM D2115-04, FIG. 3 shows the results. Example 1 and Example 2 are almost three times as heat stable as Comparative Examples B and D, respectively (15 minutes vs. 45 minutes for similar discoloration). Thus, while processing conditions make EMS a “drop-in replacement”, performance of heat stability is unexpectedly superior.

The use of a sustainable plasticizer from renewable resources, without loss of processing but with improved performance, satisfies a long-felt need.

The invention is not limited to these embodiments. The claims follow.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. A method of making flooring, comprising the steps of:
(a) mixing polyvinyl chloride resin and an effective amount of epoxidized methyl soyate to provide gelation of the mixture substantially as fast as butyl benzyl phthalate provides gelation of a mixture of the polyvinyl chloride resin and the butyl benzyl phthalate,
(b) applying to a substrate a mixture of step (a) in the form of a plastisol at a temperature to induce gelation of the plastisol and
(c) heating the plastisol and the substrate to fuse the plastisol into a solid layer affixed to the substrate.

20. The method of claim 19, further comprising the step of:
(d) applying at least one additional layer on the solid layer.

21. (canceled)

22. The method of claim 19, wherein the effective amount epoxidized methyl soyate is enough to provide both gelation and fusion of the mixture substantially as fast as butyl benzyl phthalate provides both gelation and fusion of the mixture of polyvinyl chloride resin and the butyl benzyl phthalate.

23. The method of claim 19, wherein the mixture is a plastisol and the effective amount ranges from about 15 to about 40 weight percent of the plastisol.

24. The method of claim 19, wherein the mixture is a plastisol and the effective amount ranges from about 10 to about 35 weight percent of the plastisol.

25. The method of claim 19, wherein the mixture is a compound and the effective amount ranges from about 2 to about 10 weight percent of the plastisol.

26. The method of claim 19, wherein the mixture is further comprising an optional additive selected from the group consisting of slip agents, antiblocking agents, antioxidants, ultraviolet light stabilizers, thermal stabilizers, quenchers, plasticizers, colorants, mold release agents, lubricants, antistatic agents, fire retardants, and fillers such as glass fibers, talc, chalk, or clay.

27. The method of claim 26, wherein the optional additive is present in an amount from none at all to about 5 weight percent of the plastisol.

28. The method of claim 19, wherein a frothing agent is selected from group consisting of silicone frothing agents and non-silicone frothing agents,
wherein the silicone frothing agents are copolymers of SiO₂ units and units selected from the group consisting of (CH₃)₃ SiO_{1/2} and Q(CH₃)₂ SiO_{1/2} units, wherein Q is a radical containing a solubilizing group that makes the copolymer compatible with the plastisol and the ratio of SiO₂ units to the total (CH₃)₃Si and Q(CH₃)₂Si unit is in the range of 1:0.6 to 1:1.2,
wherein non-silicone frothing agents are selected from the group consisting of urea, the sodium salt of condensed naphthalene sulfonic acid, mixed C8-C18 fatty alcohols, ammonium or sodium lauryl sulfate and water, and
wherein if a silicone frothing agent is present, optionally the mixture further comprises a frothing aid selected from the group consisting of a mixture of a phosphate ester, an organic borate ester, and an olephilic organic metallic compound.
